(19) United States
(12) Patent Application Publication
(10) Pub. No.: US 2023/0321828 A1
(43) Pub. Date: Oct. 12, 2023

(54) INFORMATION COLLECTING DEVICE, INFORMATION COLLECTING METHOD, AND STORAGE MEDIUM

(71) Applicant: NEC Corporation, Minato-ku, Tokyo (JP)

(72) Inventors: Masatsugu OGAWA, Tokyo (JP); Hiroyuki OYAMA, Tokyo (JP); Hisaya WAKAYAMA, Tokyo (JP); Masumi ICHIEN, Tokyo (JP); Nobuharu KAMI, Tokyo (JP)

(73) Assignee: NEC Corporation, Minato-ku, Tokyo (JP)

(21) Appl. No.: 18/034,618

(22) PCT Filed: Nov. 17, 2020
(86) PCT No.: PCT/JP2020/042805

§ 371 Date: Apr. 28, 2023

(51) Int. Cl. B25J 9/16

(52) U.S. Cl. CPC B25J 9/1661; B25J 9/1674; B25J 9/1664

(57) ABSTRACT

An information collecting device 3X mainly includes an information acquisition means 35X and a task identifier setting means 36X. The information acquisition means 35X is configured to acquire work related information relating to a work of a robot. Examples of the information acquisition means 35X include the information acquisition unit 35 in the first example embodiment. The task identifier setting means 36X is configured to set an identifier of a task executed by the robot to the work related information.

### TECHNICAL FIELD

The present disclosure relates to a technical field of an information collecting device, an information collecting method and a storage medium for collecting information regarding the work of a robot.

### BACKGROUND ART

A method to collect data regarding the work of a robot has been proposed. For example, Patent Literature 1 discloses a robot operation data collection system configured to set collection conditions that are the conditions to collect operation data of a robot and configured to collect the operation data of the robot satisfying the collection conditions.

### CITATION LIST

### Patent Literature

Patent Literature 1: JP 2020-046764A

### SUMMARY

### Problem to be Solved

In order to remotely control the robot, it is considered that autonomous robot control is performed by automatic generation of the robot operation sequence. In such a robot system, in order to improve accuracy of robot control, it is necessary to collect data from a robot which works in any environment and to update information to be used for robot control.

In view of the issues described above, one object of the present invention is to provide an information collecting device, an information collecting method and a storage medium capable of suitably collecting information regarding the work of a robot.

### Means for Solving the Problem

In one mode of the information collecting device, there is provided an information collecting device including:
an information acquisition means configured to acquire work related information relating to a work of a robot; and
a task identifier setting means configured to set an identifier of a task executed by the robot to the work related information.

In one mode of the information collecting method, there is provided an information collecting method executed by a computer, the information collecting method including
acquiring work related information relating to a work of a robot; and
setting an identifier of a task executed by the robot to the work related information.

In one mode of the storage medium, there is provided a storage medium storing a program executed by a computer, the program causing the computer to:
acquire work related information relating to a work of a robot; and
set an identifier of a task executed by the robot to the work related information.

### Effect

An example advantage according to the present invention is to suitably collect work related information relating to the work of a robot.

### BRIEF DESCRIPTION OF THE DRAWINGS

FIG. 1 It illustrates a configuration of a robot control system in the first example embodiment.

FIG. 2 It illustrates the hardware configuration of the robot controller.

FIG. 3 It illustrates example of the data structure of application information.

FIG. 4 It illustrates an example of the data structure of work related information.

FIG. 5 It illustrates an example of a functional block of the information collecting device.

FIG. 6 It illustrates the relation between the progress status of a subtask in the robot operation period and the task identifier set in the work related information.

FIG. 7 It illustrates an example of a functional block of the robot controller.

FIG. 8 It illustrates a bird's-eye view of the workspace when the objective task is pick-and-place.

FIG. 9 It illustrates a display example of a task designation screen image for specifying the objective task.

FIG. 10 It illustrates an example of a flowchart showing an outline of a process performed by the information collecting device in the first example embodiment.

FIG. 11 It is a schematic configuration diagram of an information collecting device according to a second example embodiment.

FIG. 12 It illustrates an example of a flowchart showing a processing procedure performed by the information collecting device in the second example embodiment.

### EXAMPLE EMBODIMENTS

Hereinafter, with reference to the drawings, example embodiments of an information collecting device, an information collecting method, a storage medium will be described.

### First Example Embodiment

(1) System Configuration

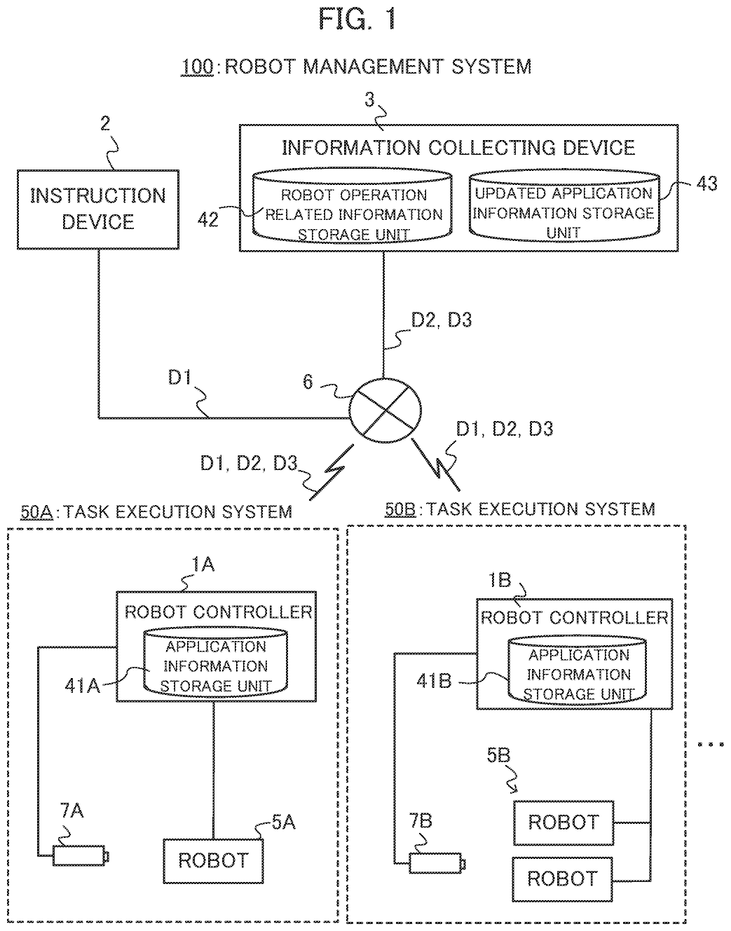

FIG. 1 shows a configuration of a robot management system 100 according to the first example embodiment. The robot management system 100 mainly includes an instruction device 2, an information collecting device 3, and a plurality of task execution systems 50 (50A, 50B, . . . ). The instruction device 2, the information collecting device 3, and the task execution systems 50 perform data communication via the communication network 6 with one another.

The instruction device 2 is a device configured to receive, from an operator, instructions regarding a task (also referred to as “objective task”) to be executed by the robot 5 in each of the task execution systems 50. The instruction device 2 performs a predetermined display or sound output related to the objective task, and supplies instruction signals “D1” generated on the basis of an input from the operator to the task execution systems 50. In this case, the instruction device 2 displays, for example, a list of the task execution systems 50 that can accept the designation of the objective task, and receives the input relating to the designation of the objective task to the task execution system 50 selected from the list. The instruction device 2 may be a tablet terminal comprising an input unit and a display unit, or it may be a stationary personal computer.

The information collecting device 3 receives information relating to the robot work (also referred to as “robot work related information D2”) from each of the task execution systems 50 and stores the received robot work related information D2. The information collecting device 3 functionally includes a robot work related information storage unit 42 and an updated application information storage unit 43. The robot work related information storage unit 42 stores the robot work related information D2 received by the information collecting device 3 from each of the task execution systems 50. The updated application information storage unit 43 stores the application information generated and updated by analyzing the information stored in the robot work related information storage unit 42. The application information includes various information necessary to generate, from the objective task, an operation sequence which is a sequence to be executed by the robot. The information collecting device 3 transmits, to the task execution systems 50, the update information “D3” required for synchronizing the application information stored in the updated application information storage unit 43 with the application information stored in the task execution systems 50.

The task execution systems 50 are systems configured to execute specified objective tasks and be provided in different environments. Each of the task execution systems 50 includes a robot controller 1 (1A, 1B, . . . ), a robot 5 (5A, 5B, . . . ) and a measurement device 7 (7A, 7B, . . . ).

When the objective task to be executed by the robot 5 belonging to the same task execution system 50 is specified, the robot controller 1 formulates the motion planning of the robot based on the temporal logic and controls the robot 5 based on the motion planning. Specifically, the robot controller 1 converts the objective task represented by temporal logic into a sequence of tasks, in a unit of time step, that the robot 5 can accept, and then controls the robot 5 based on the generated sequence. Thereafter, each task (command) into which the objective task is decomposed by a unit that the robot 5 can accept is also referred to as “subtask”, and a sequence of subtasks to be executed by the robot 5 to accomplish the objective task is referred to as “subtask sequence” or “operation sequence”.

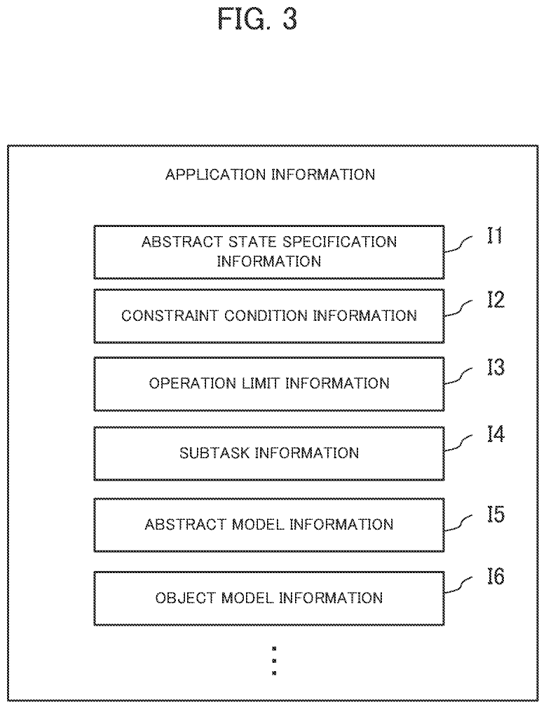

Further, the robot controller 1 has an application information storage unit 41 (41A, 41B, . . . ) which stores application information required for generating the operation sequence regarding the robot 5 from the objective task. Details of the application information will be described later with reference to FIG. 3.

Further, the robot controller 1 performs data communication with the robot 5 and the measurement device 7 belonging to the task execution system 50 to which the robot controller 1 belongs via a communication network or by wireless or wired direct communication. For example, the robot controller 1 transmits a control signal relating to the control of the robot 5 to the robot 5. In another example, the robot controller 1 receives a measurement signal generated by the measurement device 7.

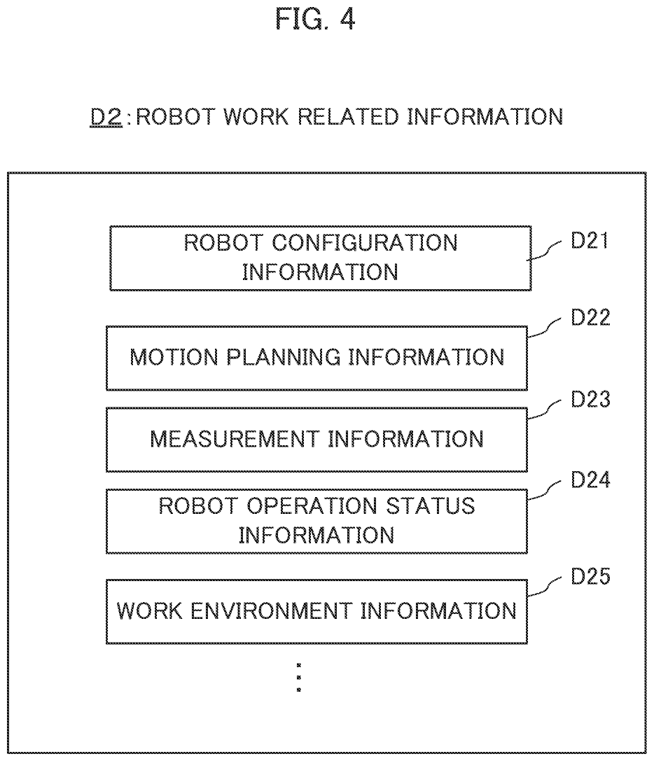

Furthermore, the robot controller 1 performs data communication with the instruction device 2 and the information collecting device 3 via the communication network 6. For example, the robot controller 1 receives, from the instruction device 2, an instruction signal D1 relating to the designation of the objective task or the operation command or the like of the robot 5. In addition, the robot controller 1 transmits the robot work related information D2, which includes various information generated in the control of the robot 5 and various information exchanged with the robot 5 and the measurement device 7, to the information collecting device 3. A detailed description of the robot work related information D2 will be described later with reference to FIG. 4. The robot controller 1 receives the update information D3 from the information collecting device 3 through the communication network 6 and updates the application information stored in the application information storage unit 41 based on the received update information D3.

Instead of being supplied to the information collecting device 3 via the robot controller 1, the robot work related information D2 generated by the robot 5 or the measurement device 7 may be directly supplied to the information collecting device 3 by the robot 5 or the measurement device 7 without passing through the robot controller 1.

One or more robots 5 are provided for each of the task execution systems 50, and each robot 5 performs operation relating to the objective task on the basis of the control signal that is supplied from the robot controller 1 belonging to the task execution system 50 to which the each robot 5 belongs. Examples of the robots 5 include a robot used in an assembly factory, a food factory, or any other factory and a robot configured to operate in logistics sites. The robot 5 may be a vertical articulated robot, a horizontal articulated robot, or any other type of a robot and may be equipped with plural targets to be controlled to operate independently such as robot arms. Further, the robot 5 may perform cooperative work with other robots, workers, or machine tools that operate in the workspace. Further, the robot controller 1 and the robot 5 may be integrally configured.

Further, the robot 5 may supply a state signal indicating the state of the robot 5 to the robot controller 1 belonging to the task execution system 50 to which the robot 5 belongs. The state signal may be an output signal from one or more sensors for detecting the state (e.g., position and angle) of the entire robot 5 or specific parts such as a joint, or may be a signal indicating the progress of the operation sequence of the robot 5 generated by a control unit of the robot 5.

The measurement device 7 is one or more sensors, such as a camera, a range sensor, a sonar, and any combination thereof, to detect a state of the workspace in which the objective task is performed in each task execution system 50. The measurement device 7 supplies the generated measurement signal to the robot controller 1 belonging to the task execution system 50 to which the measurement device 7 belongs. The measurement device 7 may be a self-propelled or flying sensor (including a drone) that moves in the workspace. The measurement device 7 may also include one or more sensors provided on the robot 5, one or more sensors provided on other objects being in the workspace, and the like. The measurement device 7 may also include one or more sensors that detect sound in the workspace. As such, the measurement device 7 may include a variety of sensors that detect the state of the workspace, and may include sensors located anywhere.

The configuration of the robot management system 100 shown in FIG. 1 is an example, and therefore various changes may be made to the configuration. For example, the robot controller 1 that exists in each task execution system 50 may be configured by a plurality of devices. In this case, the plurality of devices constituting the robot controller 1 exchange information necessary to execute the process assigned in advance with one another. The application information storage unit 41 may be stored by one or more external storage devices that perform data communication with the robot controller 1. In this case, the external storage devices may be one or more server devices for storing the application information storage unit 41 commonly referenced in each task execution system 50. Similarly, at least one of the robot work related information storage unit 42 and the updated application information storage unit 43 may be stored by one or a plurality of external storage devices that perform data communication with the information collecting device 3. In addition, each of the task execution systems 50 may be provided with one or more sensors for detecting one or more indicators such as temperature, humidity, and the like related to the work environment of the robot 5.

(2) Hardware Configuration

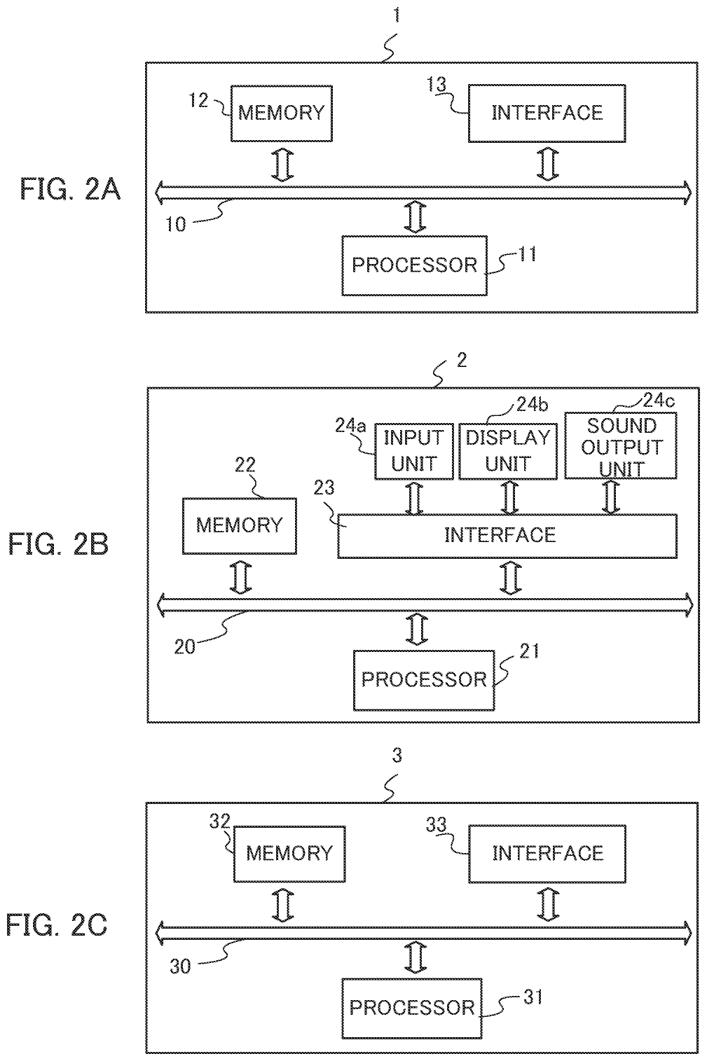

FIG. 2A shows the hardware configuration of the robot controller 1 (1A, 1B, . . . ). The robot controller 1 includes a processor 11, a memory 12, and an interface 13 as hardware. The processor 11, the memory 12 and the interface 13 are connected to one another via a data bus 10.

The processor 11 executes a program stored in the memory 12 to thereby function as a controller (arithmetic unit) configured to perform overall control of the robot controller 1. Examples of the processor 11 include a CPU (Central Processing Unit), a GPU (Graphics Processing Unit), and a TPU (Tensor Processing Unit). The processor 11 may be configured by a plurality of processors. The processor 11 is an example of a computer.

The memory 12 is configured by a variety of volatile and non-volatile memories, such as a RAM (Random Access Memory), a ROM (Read Only Memory, and a flash memory. Further, the memory 12 stores a program for the robot controller 1 to execute a process. The memory 12 functions as the application information storage unit 41. The application information stored in the application information storage unit 41 is updated based on the update information D3. A part of the information stored in the memory 12 may be stored by one or a plurality of external storage devices capable of communicating with the robot controller 1, or may be stored by a storage medium detachable from the robot controller 1.

The interface 13 is one or more interfaces for electrically connecting the robot controller 1 to other devices. Examples of these interfaces include a wireless interface, such as network adapters, for transmitting and receiving data to and from other devices wirelessly, and a hardware interface, such as cables, for connecting to other devices.

The hardware configuration of the robot controller 1 is not limited to the configuration shown in FIG. 2A. For example, the robot controller 1 may be connected to or incorporate at least one of a display device, an input device, or a sound output device.

FIG. 2B shows the hardware configuration of the instruction device 2. The instruction device 2 includes, as hardware, a processor 21, a memory 22, an interface 23, an input unit 24a, a display unit 24b, and a sound output unit 24c. The processor 21, the memory 22 and the interface 23 are connected to one another via a data bus 20. Further, the input unit 24a and the display unit 24b and the sound output unit 24c are connected to the interface 23.

The processor 21 executes a predetermined process by executing a program stored in the memory 22. The processor 21 is one or more processors such as a CPU, a GPU, and a TPU. The processor 21 receives the signal generated by the input unit 24a via the interface 23 and then generates an instruction signal D1, and transmits the instruction signal D1 to the robot controller 1 via the interface 23. The processor 21 controls, via the interface 23, at least one of the display unit 24b or the sound output unit 24c, based on the output control signal received from the robot controller 1 via the interface 23.

The memory 22 is configured by various volatile and non-volatile memories such as a RAM, a ROM, a flash memory, and the like. Further, the memory 22 stores a program for the instruction device 2 to execute a process.

The interface 23 is one or more interfaces for electrically connecting the instruction device 2 to other devices. Examples of these interfaces include a wireless interface, such as a network adapter, for transmitting and receiving data to and from other devices wirelessly, and a hardware interface, such as a cable, for connecting to other devices. The interface 23 also performs interface operations of the input unit 24a, the display unit 24b, and the sound output unit 24c. The input unit 24a is a user interface that receives input from a user, and examples of the input unit 24a include a touch panel, a button, a keyboard, and a voice input device. Examples of the display unit 24b include a display and a projector, and the display unit 24b performs display under the control of the processor 21. The sound output unit 24c is a speaker, for example, and performs sound output under the control of the processor 21.

The hardware configuration of the instruction device 2 is not limited to the configuration shown in FIG. 2B. For example, at least one of the input unit 24a, the display unit 24b, or the sound output unit 24c may be configured as a separate device that is electrically connected to the instruction device 2. The instruction device 2 may also be connected to various devices such as a camera, or may incorporate them.

FIG. 2C shows the hardware configuration of the information collecting device 3. The information collecting device 3 includes a processor 31, a memory 32, and an interface 33 as hardware. The processor 31, the memory 32 and the interface 33 are connected to one another via a data bus 30.

The processor 31 functions as a controller (arithmetic unit) which controls the entire information collection unit 3 by executing a program stored in the memory 32. The processor 31 is one or more processors such as a CPU, a GPU, and a TPU. The processor 31 may be configured by a plurality of processors. The processor 31 is an example of a computer.

The memory 32 may be configured by a variety of volatile and non-volatile memories, such as a RAM, a ROM, a flash memory, and the like. Further, the memory 32 stores a program for the information collecting device 3 to execute a process. The memory 32 functions as the robot work related information storage unit 42 and the updated application information storage unit 43. A part of the information stored in the memory 32 may be stored by one or more external storage devices that can communicate with the information collecting device 3, or may be stored by a storage medium detachable from the information collecting device 3.

The interface 33 is one or more interfaces for electrically connecting the information collecting device 3 to other devices. Examples of these interfaces include a wireless interface, such as a network adapter, for transmitting and receiving data to and from other devices wirelessly, and a hardware interface, such as a cable, for connecting to other devices.

The hardware configuration of the information collecting device 3 is not limited to the configuration shown in FIG. 2C. For example, the information collecting device 3 may be connected to or incorporate at least one of a display device, an input device, or a sound output device.

(3) Application Information

Next, a data structure of the application information stored in the application information storage unit 41 will be described.

FIG. 3 shows an example of a data structure of the application information. As shown in FIG. 3, the application information includes abstract state specification information I1, constraint condition information I2, operation limit information I3, subtask information I4, abstract model information I5, and object model information I6.

The abstract state specification information I1 specifies an abstract state to be defined in order to generate the operation sequence. The above-mentioned abstract state is an abstract state of an object in the workspace, and is defined as a proposition to be used in the target logical formula to be described later. For example, the abstract state specification information I1 specifies the abstract state to be defined for each type of objective task.

The constraint condition information I2 indicates constraint conditions at the time of performing the objective task. The constraint condition information I2 indicates, for example, a constraint that the robot 5 (robot arms) must not be in contact with an obstacle when the objective task is pick-and-place, and a constraint that the robot arms must not be in contact with each other, and the like. The constraint condition information I2 may be information in which the constraint conditions suitable for each type of the objective task are recorded.

The operation limit information I3 indicates information on the operation limit of the robot 5 to be controlled by the robot controller 1. The operation limit information I3 is information, for example, defining the upper limits of the speed, the acceleration, and the angular velocity of the robot 5. It is noted that the operation limit information I3 may be information defining the operation limit for each movable portion or joint of the robot 5.

The subtask information I4 indicates information regarding subtasks to be components of the operation sequence. The term “subtask” herein indicates a task, in a unit which can be accepted by the robot 5, obtained by decomposing the objective task and is equivalent to a segmentalized operation of the robot 5. For example, when the objective task is pick-and-place, the subtask information I4 defines a subtask “reaching” that is the movement of a robot arm of the robot 5, and a subtask “grasping” that is the grasping by the robot arm. The subtask information I4 may indicate information on subtasks that can be used for each type of objective task. The subtask information I4 may include information related to a subtask that requires an operation command generated by an external input.

The abstract model information I5 is information on an abstract model in which the dynamics in the workspace are abstracted. For example, an abstract model is represented by a model in which real dynamics are abstracted by a hybrid system, as will be described later. The abstract model Information I5 includes information indicative of the switching conditions of the dynamics in the above-mentioned hybrid system. For example, in the case of pick-and-place in which the robot 5 grasps an object (referred to as “target object”) to be targeted by the robot 5 and then place it on a predetermined position, one of the switching conditions is that the target object cannot be moved unless it is gripped by the hand of the robot arm. The abstract model information I5 includes information on an abstract model suitable for each type of the objective task.

The object model information I6 is information on the object model of each object in the workspace to be recognized from the measurement signal generated by the measurement device 7. Examples of the above-described each object include the robot 5, an obstacle, a tool and any other object handled by the robot 5, a working body other than the robot 5. The object model information I6 includes, for example, information required for the control device 1 to recognize the type, position, posture, currently-executed operation, and the like of the described above each object, and three-dimensional shape information such as CAD (Computer Aided Design) data for recognizing the three-dimensional shape of each object. The former information includes the parameters of an inference engine obtained by learning a learning model that is used in a machine learning such as a neural network. For example, the above-mentioned inference engine is preliminarily learned to output the type, the position, the posture, and the like of an object shown in the image when an image is inputted thereto. Further, when an AR marker for image recognition is attached to each main object such as a target object, information required for recognizing each main object by the AR marker may be stored as the object model information I6.

In addition to the information described above, the application information storage unit 41 may store various kinds of information related to the generation process of the operation sequence.

(4) Work Related Information

FIG. 4 shows an example of the data structure of the robot work related information D2 that is received by the information collecting device 3 from each task execution system 50. As shown in FIG. 4, the robot work related information D2 includes robot configuration information D21, motion planning information D22, measurement information D23, robot operation status information D24, and work environment information D25. The information collecting device 3 is not limited to being supplied with the whole robot work related information D2 shown in FIG. 4 at one time, and it may be sequentially supplied with individual information constituting the robot work related information D2 according to the type of information and/or the generation timing thereof. Namely, the task execution system 50 may supply the information to be transmitted as the robot work related information D2 to the information collecting device 3 in several batches.

The robot configuration information D21 is information indicating the configuration of the robot 5 in each of the task execution systems 50. Examples of the robot configuration information D21 include information regarding the number of robots 5, information regarding the arrangement of each robot 5, and information regarding the type of each robot 5. The robot configuration information D21 may include not only information regarding the configuration of the robot 5 but also information regarding the configuration (e.g., the number, the arrangement, the type) of the measurement device 7. The robot configuration information D21 may be supplied to the information collecting device 3 in advance of other information to be transmitted to the information collecting device 3 as the robot work related information D2.

The motion planning information D22 is information relating to the motion planning of the robot 5 that is formulated by the robot controller 1 in each of the task execution systems 50. For example, the motion planning information D22 may include not only the control signal relating to the operation sequence that the robot controller 1 supplies to the robot 5 but also any information (intermediate product information) generated in the process of generating the control signal. For example, the motion planning information D22 may include information regarding the set objective task, information regarding the abstract state (including propositions) set by the robot controller 1, information regarding the evaluation function (reward function, value function) used in determining the operation sequence, and the like. The motion planning information D22 may include version information regarding the application information used by the robot controller 1. Further, the motion planning information D22 includes date and time information indicating the date and time of generating the operation sequence and the scheduled execution date and time of each subtask constituting the operation sequence. The motion planning information D22 may be immediately supplied to the information collecting device 3 after the establishment of the motion planning by the robot controller 1, or may be collectively supplied to the information collecting device 3 together with other information to be transmitted to the information collecting device 3 as robot work related information D2.

The measurement information D23 is a measurement signal that is generated by the measurement device 7 provided in each of the task execution systems 50 during the execution of the objective task by the robots 5. This measurement signal is associated with date and time information indicating the measurement date and time.

The robot operation status information D24 is information indicating the operation status of the robot 5 during a time period (also referred to as “robot operation period”) in which the robot operates based on the control signal of the operation sequence generated by the robot controller 1 in each of the task execution systems 50. The robot operation status information D24 may be log information indicating the execution result (success or failure) of the robot 5 for each subtask, or may be log information regarding the status of the robot 5 in execution of the operation sequence. Examples of the log information regarding the status includes information regarding the operation time length of the robot 5 and information relating to the angle, the angular velocity, the angular acceleration, the position, the velocity, the acceleration, the driving force, and the torque of the end effector or the actuator of the robot 5. These records of the log information are associated with the date and time information that indicates the execution date and time of the operation of interest. The robot operation status information D24 may be information generated by the robot controller 1, or may be information generated by the robot 5, or may include the both information.

The work environment information D25 is detection information regarding the work environment detected in each of the task execution systems 50. The work environment information D25 is, for example, an index that represents the environment, such as the temperature and humidity, of the workspace during the robot operation period.

The measurement information D23, the robot operation status information D24 and the work environment information D25 may be supplied to the information collecting device 3 at predetermined time intervals during the robot operation period, or may be supplied collectively after the end of the robot operation period to the information collecting device 3.

The robot work related information D2 is not limited to the above-described information, but may include any information related to the work of the robot 5. For example, the robot work related information D2 may include identification information assigned to each of the task execution systems 50.

(5) Processing Outline of Information Collecting Device

Next, a description will be given of the processing outline of the information collecting device 3. In general, when the robot work related information D2 supplied from each of the task execution systems 50 is stored in the robot work related information storage unit 42, the information collecting device 3 sets an identifier (also referred to as “task identifier”) representing the task to be executed in the robot work related information D2. Thus, when data of the robots working in a plurality of environments is collected, the information collecting device 3 sorts the collected data so that the collected data is utilized for the analysis and the learning for the purpose of updating the application information.

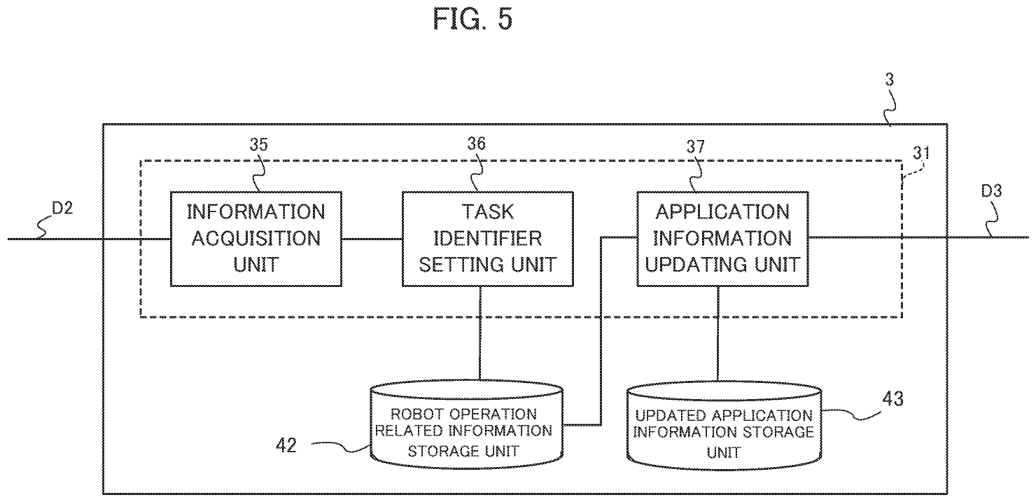

FIG. 5 is an example of a functional block showing a processing outline of the information collecting device 3. The processor 31 of the information collecting device 3 functionally includes an information acquisition unit 35, a task identifier setting unit 36, and an application information updating unit 37. In FIG. 5, although an example of data in which transfer is performed between the blocks is shown, it is not limited thereto. The same applies to the drawings of other functional blocks described below.

The information acquisition unit 35 receives the robot work related information D2 from each of the task execution systems 50 through the interface 33 and supplies the received robot work related information D2 or a part thereof to the task identifier setting unit 36. The details of the process of the information acquisition unit 35 will be explained in the section “(6) Details of Information Acquisition Unit”.

Each of the task execution systems 50 may transmit the robot work related information D2 at predetermined time intervals during a time period from the start of the execution (including the motion planning) of the objective task to the end of the execution of the objective task, or may transmit the robot work related information D2 in a lump at a predetermined timing, such as a timing when the execution of the objective task is completed. The information acquisition unit may also receive the robot work related information D2 by requesting the robot work related information D2 to each of the task execution systems 50. In this case, for example, the information acquisition unit 35 recognizes the task execution system 50 executing the objective task by receiving the instruction information of the objective task from the instruction device 2, and requests the robot controller 1 of the task execution system 50 executing the objective task to transmit the robot work related information D2.

The task identifier setting unit 36 executes a process (so-called tagging process) of setting the task identifier as a tag to the robot work related information D2 supplied from the information acquisition unit 35, and stores the robot work related information D2 to which the task identifier is set in the robot work related information storage unit 42. In this case, the task identifier is an identifier for at least identifying the subtask. The details of the process executed by the task identifier setting unit 36 are described in detail in the section “(7) Details of Task Identifier Setting Unit”.

The application information updating unit 37 updates the application information based on the information stored in the robot work related information storage unit 42 and stores the updated application information in the updated application information storage unit 43. In this case, the application information updating unit 37 updates at least one of the abstract state specification information I1, the constraint condition information I2, the operation limit information I3, the subtask information I4, the abstract model information I5, or the object model information I6 by performing analysis and learning using the robot work related information stored in the robot work related information storage unit 42 with respect to each task classified according to the set task identifier. In this case, the application information updating unit 37 may receive an external input from the manager or the like through the input unit connected via the interface 33 and perform the above-described update based on the external input.

The application information updating unit 37 distributes the update information D3 representing the updated application information to the task execution systems 50. In this case, for example, the application information updating unit 37 distributes all updated application information stored in the updated application information storage unit 43 to the task execution systems 50 as the update information D3. In another example, the application information updating unit 37 distributes only the application information corresponding to the updated portion to the respective task execution systems 50 as the update information D3. Thereafter, the robot controller 1 of the task execution system 50 that receives the update information D3 updates the application information stored in the application information storage unit 41 based on the update information D3.

Here, each component of the information acquisition unit 35, the task identifier setting unit 36, and the application information updating unit 37 can be realized, for example, by the processor 31 which executes a program. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components. Further, at least a part of the components may be configured by a ASSP (Application Specific Standard Produce), ASIC (Application Specific Integrated Circuit) and/or a quantum processor (quantum computer control chip). In this way, each component may be implemented by a variety of hardware. The above is true for other example embodiments to be described later. Further, each of these components may be realized by the collaboration of a plurality of computers, for example, using cloud computing technology.

(6) Details of Information Acquisition Unit

A detailed description will be given of the processing performed by the information acquisition unit 35. In some embodiments, the information acquisition unit 35 determines whether or not the received robot work related information D2 satisfies one or more predetermined collection conditions, and supplies the robot work related information D2 which satisfies the collection condition to the task identifier setting unit 36. Thereby, the processing load due to the setting process of the task identifier by the task identifier setting unit 36 is suitably reduced.

The term “collection conditions” herein indicates one or more conditions for determining robot work related information D2 to be stored in the robot work related information storage unit 42 in association with the task identifier. Examples of the collection conditions include a condition for specifying the task execution system 50 from which the robot work related information D2 is to be stored in the robot work related information storage unit 42, or a condition for specifying a time slot in which the robot work related information D2 is to be stored in the robot work related information storage unit 42. The information for specifying a specific collection condition is stored in advance in the memory 32, for example.

In another example, the collection condition may be a condition that specifies the configuration of the robot 5 being in the task execution systems 50. In this instance, the information acquisition unit 35 specifies one or more task execution systems 50 having the configuration of the robot 5 that is set as the collection condition based on the robot configuration information D21 that is transmitted as the robot work related information D2. Then, the information acquisition unit 35 supplies the robot work related information D2 transmitted from the task execution systems 50 having the configuration of the robot 5 set as the collection condition to the task identifier setting unit 36.

The information acquisition unit 35 may discard the robot work related information D2 that does not satisfy the collection conditions without being stored in the robot work related information storage unit 42, or may store the information in the robot work related information storage unit 42 as it is without performing the setting process of the task identifier. In either of these cases, it is possible to reduce the load in the task identifier setting process by the task identifier setting unit 36. In this instance, for example, the setting information that defines the treatment to be applied to the robot work related information D2 which does not satisfy the collection condition is stored in the memory 32 or the like in advance, and the information acquisition unit 35 determines, according to the setting information, the treatment (discard or store in the robot work related information storage unit 42) to be applied to the robot work related information D2 which does not satisfy the collection condition.

(7) Details of Task Identifier Setting Unit

Next, the details of the task identifier setting process will be described. The task identifier setting unit 36 sets a task identifier representing at least the corresponding subtask as a tag to the robot work related information D2 (for example, the measurement information D23, the robot operation status information D24, and the work environment information D25) generated during the robot operation period. Specifically, the task identifier setting unit 36 recognizes the execution period of each subtask of the robot 5 executed in the robot operation period and sets the task identifier of the each subtask to the robot work related informational D2 generated in the recognized execution period of the each subtask.

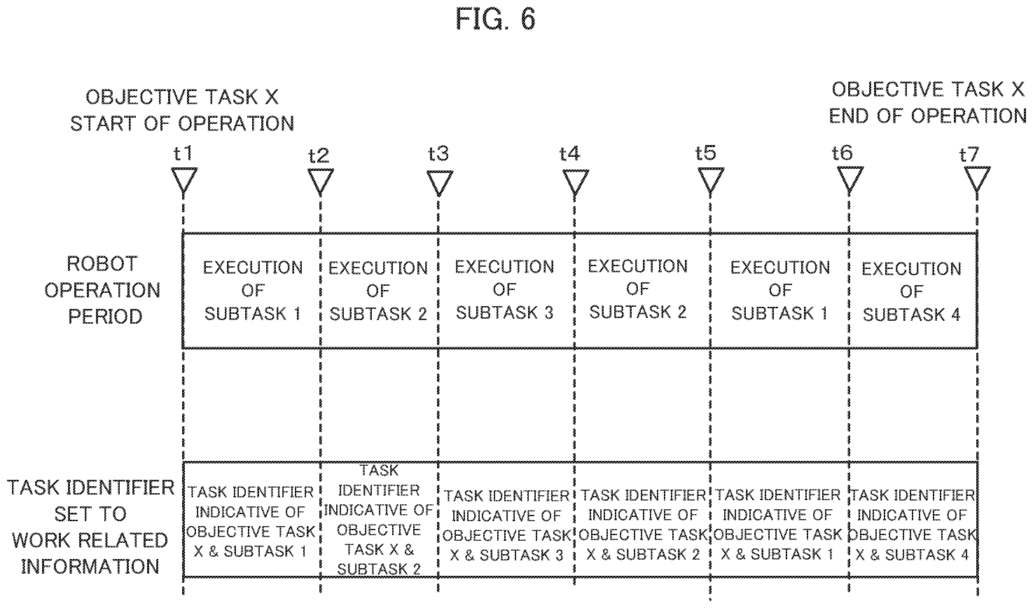

FIG. 6 is a diagram illustrating a relation between a progress status of a subtask in a robot operation period in a certain task execution system 50 and the task identifier to be attached to the robot work related information D2 generated in the robot operation period. In the example shown in FIG. 6, the period from the time “t1” to the time “t7” corresponds to the robot operation period in the task execution system 50A, and the robot 5 executes subtasks “subtask 1” to “subtask 4” in the robot operation period.

The task identifier setting unit 36 recognizes the execution period of each subtask to be executed in the robot execution period based on the motion planning information D22 or the robot operation status information D24 included in the robot work related information D2. Specifically, the task identifier setting unit 36 refers to at least one of the motion planning information D22 indicating the information regarding the time step sequence of planned subtasks or the robot operation status information D24 indicating the log information regarding the subtasks actually-executed by the robot 5 and recognizes the execution period of each subtask. Then, the task identifier setting unit 36 associates the robot work related information D2 generated during the robot operation period with the execution period of the each subtask on the basis of the time information included in the robot work related information D2.

Specifically, the task identifier setting unit 36 recognizes that the period from the time t 1 to the time “t2” and the period from the time “t5” to the time “t6” is the execution period of the “subtask 1”. The task identifier setting unit 36 recognizes that the period from the time t2 to the time t3 and the period from the time t4 to the time t5 is the execution period of the subtask 2. Further, the task identifier setting unit 36 recognizes that the period from the time t3 to the time t4 is the execution period of the subtask 3, and the period from the time t6 to the time t7 is the execution period of the subtask 4.

The task identifier setting unit 36 sets the task identifier representing at least the corresponding subtask to the segmented robot work related information D2 for each execution period of the subtask. In the example of FIG. 6, the task identifier setting unit 36 sets the task identifier for identifying both the objective task X and the corresponding subtask. For example, the task identifier setting unit 36 sets a task identifier representing “objective task X” and “the subtask 1” to the robot work related information D2 whose date and time information is associated with the period from the time t1 to the time t2. Further, the task identifier setting unit 36 sets a task identifier representing “objective task X” and “subtask 2” to the robot work related information D2 whose date and time information is associated with the period from the time t2 to the time t3. The task identifier may be a combination of a unique identifier of the subtask of interest and a unique identifier of the objective task of interest, or may be a unique identifier for the combination of the subtask and the objective task.

In this way, the task identifier setting unit 36 sets the task identifier corresponding to the objective task and the subtask that were being executed at the time of the generation to the robot work related information D2 supplied from each task execution system 50. Thus, the task identifier setting unit 36 can store the information in the robot work related information storage unit 42 tagged so as to allow the application information updating unit 37 to analyze the execution result of each subtask. By setting such a task identifier, for example, it can be expected that it will make it easier to know the subtasks in which the failure occurred, and to facilitate learning with respect to each subtask.

(8) Control by Robot Controller

Next, the control of the robot 5 executed by the robot controller 1 in each task execution system 50 will be described. As described below, the robot controller 1 plans the operation of the robot 5 based on the temporal logic.

(8-1) Functional Block

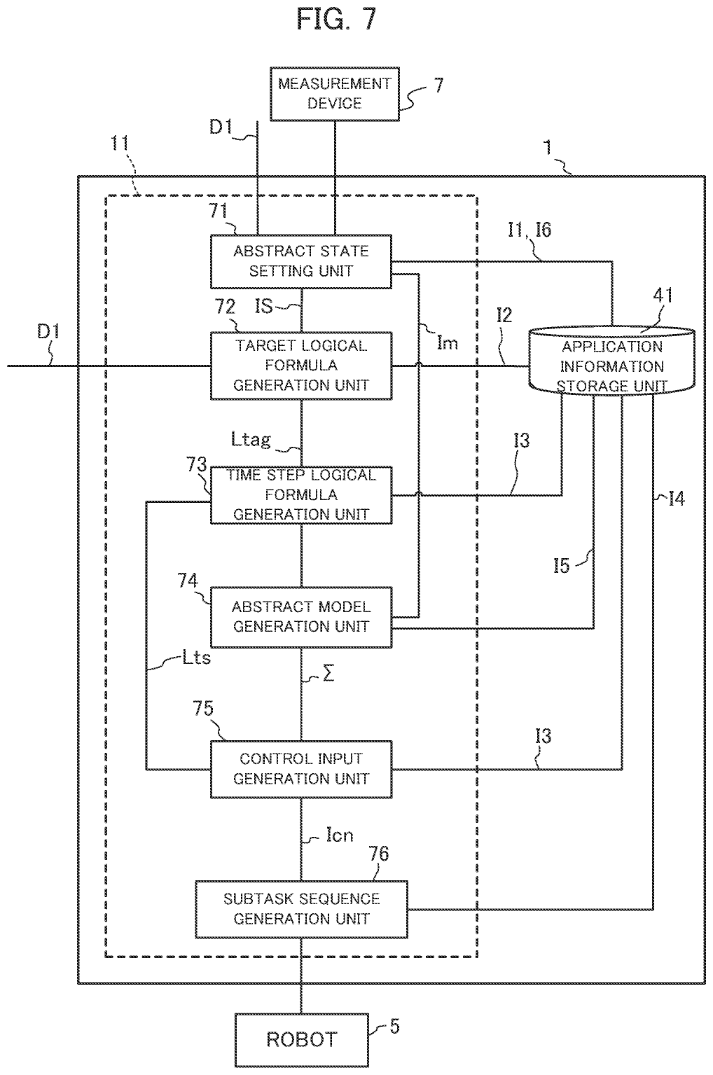

FIG. 7 is an example of a functional block showing the functional configuration of the processor 11 of the robot controller 1. The processor 11 functionally includes an abstract state setting unit 71, a target logical formula generation unit 72, a time step logical formula generation unit 73, an abstract model generation unit 74, a control input generation unit 75, and a subtask sequence generation unit 76.

The abstract state setting unit 71 sets abstract states in the workspace based on: the measurement signal supplied from the measurement device 7; the instruction signal D1 instructing the execution of the objective task; the abstract state designation information I1; and the object model information I6. In this instance, the abstract state setting unit 71 recognizes objects being in the workspace that needs to be considered in executing the objective task and generates recognition result Im relating to the objects. Based on the recognition result Im, the abstract state setting unit 71 defines propositions to be expressed in logical formulas for respective abstract states that need to be considered in executing the objective task. When the instruction signal D1 is supplied, the abstract state setting unit 71 supplies information (also referred to as “abstract state setting information I5”) representing the set abstract states to the target logical formula generation unit 72.

Based on the abstract state setting information I5, the target logical formula generation unit 72 converts the objective task specified by the instruction signal D1 into a logical formula (also referred to as a “target logical formula Ltag”), in the form of the temporal logic, representing the final state to be achieved. In this case, the target logical formula generation unit 72 refers to the constraint condition information I2 from the application information storage unit 41 and adds the constraint conditions to be satisfied in executing the objective task to the target logical formula Ltag. The target logical formula generation unit 72 supplies the generated target logical formula Ltag to the time step logical formula generation unit 73.

The time step logical formula generation unit 73 converts the target logical formula Ltag supplied from the target logical formula generation unit 72 into a logical formula (also referred to as “time step logical formula Lts”) representing the states at every time step. The time step logical formula generation unit 73 supplies the generated time step logical formula Lts to the control input generation unit 75.

The abstract model generation unit 74 generates an abstract model “Σ” in which the real dynamics in the workspace are abstracted, based on the abstract model information I5 stored in the application information storage unit 41 and the recognition result Im supplied from the abstract state setting unit 71. In this case, the abstract model generation unit 74 considers the target dynamics as a hybrid system in which the continuous dynamics and the discrete dynamics are mixed, and generates the abstract model E based on the hybrid system. The method of generating the abstract model E will be described later. The abstract model generation unit 74 supplies the generated abstract model E to the control input generation unit 75.

The control input generation unit 75 determines a control input to the robot 5 for each time step so that the time step logic formula Lts supplied from the time step logical formula generation unit 73 and the abstract model Σ supplied from the abstract model generation unit 74 are satisfied and so that the evaluation function (e.g., a function representing the amount of energy consumed by the robot) is optimized. Then, the control input generation unit 75 supplies information (also referred to as “control input information Icn”) indicating the control input to the robot 5 for each time step to the subtask sequence generation unit 76.

The subtask sequence generation unit 76 generates a subtask sequence Sr which is a sequence of subtasks based on the control input information Icn supplied from the control input generation unit 75 and the subtask information I4 stored in the application information storage unit 41, and supplies the subtask sequence Sr to the robot 5.

(8-2) Abstract State Setting Unit

First, the abstract state setting section 71 generates the recognition result Im by referring to the object model information I6 and analyzing the measurement signal according to a technique (e.g., a technique using an image processing technique, an image recognition technique, a speech recognition technique, and a RFID (Radio Frequency Identifier) related technique) for recognizing the environment of the workspace. The recognition result Im includes such information as type, position, and posture of the objects being in the workspace. Examples of the objects being in the workspace include a robot 5, a target object such as a tool or a part handled by the robot 5, an obstacle and any other working body (a working person or any other working object other than the robot 5).

Next, the abstract state setting unit 71 sets the abstract states in the workspace based on the recognition result Im and the abstract state designation information I1 acquired from the application information storage unit 41. In this case, first, the abstract state setting unit 71 refers to the abstract state specification information I1, and recognizes the abstract states to be set in the workspace. The abstract states to be set in a workspace vary depending on the type of objective task. Therefore, when the abstract states to be set for each type of the objective task is specified in the abstract state designation information I1, the abstract state setting unit 71 refers to the abstract state designation information I1 corresponding to the objective task specified by the instruction signal D1 and recognizes the abstract states to be set.

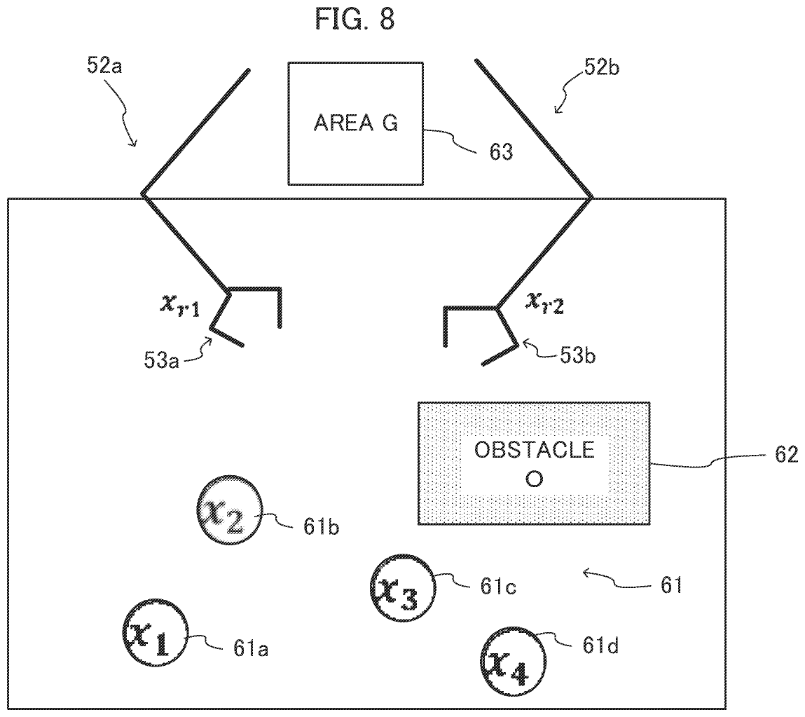

FIG. 8 shows a bird's-eye view of the workspace when pick-and-place is set as the objective task. In the workspace shown in FIG. 8, there are two robot arms 52a and 52b, four target objects 61 (61a to 61d), an obstacle 62, and an area G that is the destination of the target objects 61.

In this case, first, the abstract state setting unit 71 recognizes the states of the target objects 61, the existence range of the obstacle 62, the state of the robot 5, the existence range of the area G, and the like.

Here, the abstract state setting unit 71 recognizes the position vectors “x₁” to “x₄” indicative of the centers of the target objects 61a to 61d as the positions of the target objects 61a to 61d, respectively. Further, the abstract state setting unit 71 recognizes the position vector “xᵣ₁” of the robot hand 53a for grasping a target object as the position of the robot arm 52a and the position vector “xᵣ₂” of the robot hand 53b for grasping a target object as the position of the robot arm 52b.

Similarly, the abstract state setting unit 71 recognizes the postures of the target objects 61a to 61d (it is unnecessary in the example of FIG. 8 because each target object is spherical), the existence range of the obstacle 62, the existence range of the area G, and the like. For example, when assuming that the obstacle 62 is a rectangular parallelepiped and the area G is a rectangle, the abstract state setting unit 71 recognizes the position vector of each vertex of the obstacle 62 and the area G.

The abstract state setting unit 71 determines the abstract states to be defined in the objective task by referring to the abstract state specification information I1. In this case, the abstract state setting unit 71 determines propositions indicating the abstract states based on: the recognition result (e.g., the number of objects for each type) relating to the objects being in the workspace; and the abstract state specification information I1.

In the example of FIG. 8, the abstract state setting unit 71 assigns identification labels “1” to “4” to the target objects 61a to 61d specified by the recognition result Im, respectively. Further, the abstract state setting unit 71 defines a proposition “gᵢ” that the target object “i” (i=1 to 4) exists in the area G that is the goal point to be finally placed. Further, the abstract state setting unit 71 assigns an identification label “O” to the obstacle 62 and defines the proposition “oᵢ” that the target object i interferes with the obstacle O. Furthermore, the abstract state setting unit 71 defines a proposition “h” that a robot arm 52 interferes with another robot arm 52. The abstract state setting unit 71 may further define the proposition “vᵢ” that the target object “i” exists on the work table (the table in which the target objects and the obstacle exist in their initial states), the proposition “wᵢ” that a target object exists in the non-work area other than the work table and the area G. The non-work area is, for example, an area (floor surface and the like) in which a target object exists when the target object fell down from the work table.

In this way, by referring to the abstract state specification information I1, the abstract state setting unit 71 recognizes the abstract states to be defined, and defines the propositions (gᵢ, oᵢ, h in the above-described example) representing the abstract states according to the number of the target objects 61, the number of the robot arms 52, the number of the obstacles 62, and the number of the robots 5. The abstract state setting unit 71 supplies the target logical formula generation unit 72 with the abstract state setting information Is which includes the information indicative of the propositions representing the abstract states.

(8-3) Target Logical Formula Generation Unit

First, the target logical formula generation unit 72 converts the objective task specified by the instruction signal D1 into a logical formula using the temporal logic.

For example, in the example of FIG. 8, it is herein assumed that the objective task “the target object (i=2) finally exists in the area G” is given. In this case, the target logical formula generation unit 72 generates the logical formula “⋄g₂” which represents the objective task by using the operator “⋄” corresponding to “eventually” of the linear logical formula (LTL: Linear Temporal Logic) and the proposition “gᵢ” defined by the abstract state setting unit 71. The target logical formula generation unit 72 may express the logical formula by using any operators according to the temporal logic other than the operator “⋄” such as logical AND “∧”, logical OR “∨”, negative “¬”, logical implication “⇒”, always “□”, next “∘”, and until “U”. The logical formula may be expressed by any temporal logic other than linear temporal logic such as MTL (Metric Temporal Logic) and STL (Signal Temporal Logic).

The instruction signal D1 may be information specifying the objective task in a natural language. There are various techniques for converting a task expressed in a natural language into a logical formula.

Next, the target logical formula generation unit 72 generates the target logical formula Ltag by adding the constraint conditions indicated by the constraint condition information I2 to the logical formula indicating the objective task.

For example, provided that two constraint conditions “a robot arm 52 does not interfere with another robot arm 52” and “the target object i does not interfere with the obstacle O” for pick-and-place shown in FIG. 8 are included in the constraint condition information I2, the target logical formula generation unit 72 converts these constraint conditions into the logical formula. Specifically, the target logical formula generation unit 72 converts the above-described two constraint conditions into the following logical formulas, respectively, using the proposition “oᵢ” and the proposition “h” defined by the abstract state setting unit 71 in the case shown in FIG. 8.

□¬h

∧ᵢ□¬oᵢ

Therefore, in this case, the target logical formula generation unit 72 generates the following target logical formula Ltag obtained by adding the logical formulas of these constraint conditions to the logical formula “⋄g₂” corresponding to the objective task “the target object (i=2) finally exists in the area G”.

(⋄g₂)∧(□¬h)∧(∧ᵢ□¬oᵢ)

In practice, the constraint conditions corresponding to the pick-and-place is not limited to the above-described two constraint conditions and there are other constraint conditions such as “a robot arm 52 does not interfere with the obstacle O”, “plural robot arms 52 do not grasp the same target object”, “target objects does not contact with each other”. Such constraint conditions are also stored in the constraint condition information I2 and are reflected in the target logical formula Ltag.

(8-4) Time Step Logical Formula Generation Unit

The time step logical formula generation unit 73 determines the number of time steps (also referred to as the “target time step number”) needed to complete the objective task, and determines possible combinations of propositions representing the states at every time step such that the target logical formula Ltag is satisfied with the target time step number. Since the combinations are normally plural, the time step logical formula generation unit 73 generates the time step logical formula Lts that is a logical formula obtained by combining these combinations by logical OR. Each of the combinations described above is a candidate of a logical formula representing a sequence of operations to be instructed to the robot 5, and therefore it is hereinafter also referred to as “candidate φ”.

Here, a description will be given of a specific example of the process executed by the time step logical formula generation unit 73 in the case where the objective task “the target object (i=2) finally exists in the area G” exemplified in FIG. 8 is set.

In this instance, the following target logical formula Ltag is supplied from the target logical formula generation unit 72 to the time step logical formula generation unit 73.

(⋄g₂)∧(□¬h)∧(∧ᵢ□¬oᵢ)

In this case, the time-step logical formula generation unit 73 uses the proposition “g_{i, k}” that is the extended proposition “gᵢ” to include the concept of time steps. Here, the proposition “g_{i, k}” is the proposition “the target object i exists in the area G at the time step k”. Here, when the target time step number is set to “3”, the target logical formula Ltag is rewritten as follows.

(⋄g_{2,3})∧(∧_{k=1,2,3}□¬hₖ)∧(∧_{i,k=1,2,3}□¬oᵢ)

⋄g_{2,3} can be rewritten as shown in the following expression.

⋄g_{2,3}=(¬g_{2,1}∧¬g_{2,2}∧g_{2,3})∨(¬g_{2,1}∧g_{2,2}∧g_{2,3})∨(g_{2,1}∧¬g_{2,2}∧g_{2,3})∨(g_{2,1}∧g_{2,2}∧g_{2,3}) [Formula 1]

The target logical formula Ltag described above is represented by logical OR (φ₁∨φ₂∨φ₃∨φ₄) of four candidates “φ₁” to “φ₄” as shown in below.

ϕ₁=(¬g_{2,1}∧¬g_{2,2}∧g_{2,3})∧(∧_{k=1,2,3}□¬hₖ)∧(∧_{i,k=1,2,3}□¬o_{i,k})

ϕ₂=(¬g_{2,1}∧g_{2,2}∧g_{2,3})∧(∧_{k=1,2,3}□¬hₖ)∧(∧_{i,k=1,2,3}□¬o_{i,k})

ϕ₃=(g_{2,1}∧¬g_{2,2}∧g_{2,3})∧(∧_{k=1,2,3}□¬hₖ)∧(∧_{i,k=1,2,3}□¬o_{i,k})

ϕ₄=(g_{2,1}∧g_{2,2}∧g_{2,3})∧(∧_{k=1,2,3}□¬hₖ)∧(∧_{i,k=1,2,3}□¬o_{i,k}) [Formula 2]

Therefore, the time step logical formula generation unit 73 determines the time step logical formula Lts to be the logical OR of the four candidates φ₁ to φ₄. In this case, the time step logical formula Lts is true if at least one of the four candidates φ₁ to φ₄ is true.

Next, a supplementary description will be given of a method of setting the target time step number.

For example, the time step logical formula generation unit 73 determines the target time step number based on the prospective work time specified by the instruction signal D1 supplied from the instruction device 2. In this case, the time step logical formula generation unit 73 calculates the target time step number based on the prospective work time described above and the information on the time width per time step stored in the memory 12 or the storage device 4. In another example, the time step logical formula generation unit 73 stores in advance in the memory 12 or the storage device 4 information in which a suitable target time step number is associated with each type of objective task, and determines the target time step number in accordance with the type of objective task to be executed by referring to the information.

In some embodiments, the time step logical formula generation unit 73 sets the target time step number to a predetermined initial value. Then, the time step logical formula generation unit 73 gradually increases the target time step number until the time step logical formula Lts which enables the control input generation unit 75 to determine the control input is generated. In this case, if the control input generation unit 75 ends up not being able to derive the optimal solution in the optimization processing with the set target time step number, the time step logical formula generation unit 73 adds a predetermined number (1 or more integers) to the target time step number.

At this time, the time step logical formula generation unit 73 may set the initial value of the target time step number to a value smaller than the number of time steps corresponding to the work time of the objective task expected by the user. Thus, the time step logical formula generation unit 73 suitably suppresses setting the target time step number to an unnecessarily large number.

(8-5) Abstract Model Generation Unit

The abstract model generation unit 74 generates the abstract model Σ based on the abstract model information I5 and the recognition result Im. Here, in the abstract model information I5, information required to generate the abstract model Σ is recorded for each type of objective task. For example, when the objective task is a pick-and-place, a general-purpose abstract model is recorded in the abstract model information I5, wherein the position or the number of target objects, the position of the area where the target objects are to be placed, the number of robots 5 (or the number of robot arms 52), and the like are not specified in the general-purpose abstract model. The abstract model generation unit 74 generates the abstract model Σ by reflecting the recognition result Im in the general-purpose abstract model which includes the dynamics of the robot 5 and which is recorded in the abstract model information I5. Thereby, the abstract model Σ is set to a model in which the states of objects being in the workspace and the dynamics of the robot 5 are abstractly expressed. In the case of pick-and-place, the states of the objects being in the workspace indicate the position and the number of the target objects, the position of the area where the target object are to be placed, the number of robots 5, and the like.

When there are one or more other working bodies, information on the abstracted dynamics of the other working bodies may be included in the abstract model information I5. In this case, the abstract model Σ is a model in which the states of the objects being in the workspace, the dynamics of the robot 5, and the dynamics of the other working bodies are abstractly expressed.

Here, at the time of work of the objective task by the robot 5, the dynamics in the workspace is frequently switched. For example, in the case of pick-and-place, while the robot arm 52 is gripping the target object i, the target object i can be moved. However, if the robot arm 52 is not gripping the target object i, the target object i cannot be moved.

In view of the above, in the present example embodiment, in the case of pick-and-place, the operation of grasping the target object i is abstractly expressed by the logical variable “6,”. In this case, for example, the abstract model generation unit 74 can define the abstract model Σ to be set for the workspace shown in FIG. 8 as the following equation (1).

$$[ Formula 3 ]$$

$${[ \begin{matrix}{x}_{r 1} \\ {x}_{r 2} \\ {x}_{1} \\ ⋮ \\ {x}_{4}\end{matrix} ]}_{k + 1} = {I [ \begin{matrix}{x}_{r 1} \\ {x}_{r 2} \\ {x}_{1} \\ ⋮ \\ {x}_{4}\end{matrix} ]}_{k} + [ \begin{matrix}I & 0 \\ 0 & I \\ {δ}_{1 , 1} I & {δ}_{2 , 1} I \\ ⋮ & ⋮ \\ {δ}_{1 , 4} I & {δ}_{2 , 4} I\end{matrix} ] [ \begin{matrix}{u}_{1} \\ {u}_{2}\end{matrix} ] \\ {h}_{{ij}_{min}} ( 1 - {δ}_{i} ) \leq {h}_{ij} ( x ) \leq {h}_{{ij}_{max}} {δ}_{i} + ( {δ}_{i} - 1 ) ε \qquad ( 1 )$$

Here, “uⱼ” indicates a control input for controlling the robot hand j (“j=1” is the robot hand 53a, “j=2” is the robot hand 53b), and “I” indicates a unit matrix and “0” indicates zero (null) matrix. It is noted that the control input is herein assumed to be a speed as an example but it may be an acceleration. Further, “δ_{j, i}” is a logical variable that is set to “1” when the robot hand j grasps the target object i and is set to “0” in other cases. Each of “xᵣ₁” and “xᵣ₂” indicates the position vector of the robot hand j (j=1, 2), and each of “x₁” to “x₄” indicates the position vector of the target object i (i=1 to 4). Further, “h (x)” is a variable to be “h (x)>=0” when the robot hand exists in the vicinity of a target object to the extent that it can grasp the target object, and satisfies the following relationship with the logical variable δ.

δ=1⇔h(x) [symbol] O

In the above expression, when the robot hand exists in the vicinity of a target object to the extent that the target object can be grasped, it is considered that the robot hand grasps the target object, and the logical variable δ is set to 1.

Here, the equation (1) is a difference equation showing the relationship between the states of the objects at the time step k and the states of the objects at the time step k+1. Then, in the above equation (1), the state of grasping is represented by a logical variable that is a discrete value, and the movement of the target object is represented by a continuous value. Accordingly, the equation (1) shows a hybrid system.

The equation (1) considers not the detailed dynamics of the entire robot 5 but only the dynamics of the robot hand, which is the hand of the robot 5 that actually grasps a target object. Thus, it is possible to suitably reduce the calculation amount of the optimization process by the control input generation unit 75.

Further, the abstract model information I5 includes: information for deriving the difference equation indicated by the equation (1) from the recognition result Im; and the logical variable corresponding to the operation (the operation of grasping a target object i in the case of pick-and-place) causing the dynamics to switch. Thus, even when there is a variation in the position and the number of the target objects, the area (area G in FIG. 8) where the target objects are to be placed and the number of the robots 5 and the like, the abstract model generation unit 74 can determine the abstract model Σ in accordance with the environment of the target workspace based on the abstract model information I5 and the recognition result Im.

It is noted that, in place of the model shown in the equation (1), the abstract model generation unit 74 may generate any other hybrid system model such as mixed logical dynamical (MLD) system and a combination of Petri nets and automaton.

(8-6) Control Input Generation Unit

The control input generation unit 75 determines the optimal control input for the robot 5 with respect to each time step based on the time step logical formula Lts supplied from the time step logical formula generation unit 73 and the abstract model Σ supplied from the abstract model generation unit 74. In this case, the control input generation unit 75 defines an evaluation function for the objective task and solves the optimization problem of minimizing the evaluation function while setting the abstract model Σ and the time step logical formula Lts as constraint conditions. For example, the evaluation function is predetermined for each type of the objective task and stored in the memory 12 or the storage device 4.

For example, when the objective task is pick-and-place, the control input generation unit 75 determines the evaluation function such that the control input “uₖ” and the distance “dₖ” between the target object to be carried and the goal point of the target object are minimized (i.e., the energy spent by the robot 5 is minimized). The distance dₖ described above corresponds to the distance between the target object 2 and the area G when the objective task is “the target object (i=2) finally exists in the area G”.

For example, the control input generation unit 75 determines the evaluation function to be the sum of the square of the distance dₖ and the square of the control input uₖ in all time steps. Then, the control input generation unit 75 solves the constrained mixed integer optimization problem shown in the following expression (2) while setting the abstract model Σ and the time-step logical formula Lts (that is, the logical OR of the candidates φᵢ) as the constraint conditions.

$$[ Formula 4 ]$$

$${min}_{u} ( {\sum }_{k = 0}^{T} ( {‖ {d}_{k} ‖}_{2}^{2} + {‖ {u}_{k} ‖}_{2}^{2} ) ) \\ s . t . \sum \\ ⋁ {ϕ}_{i} \qquad ( 2 )$$

Here, “T” is the number of time steps to be set in the optimization and it may be a target time step number or may be a predetermined number smaller than the target time step number as described later. In some embodiments, the control input generation unit 75 approximates the logical variable to a continuous value (i.e., solve a continuous relaxation problem). Thereby, the control input generation unit 75 can suitably reduce the calculation amount. When STL is adopted instead of linear temporal logic (LTL), it can be described as a nonlinear optimization problem.

Further, if the target time step number is large (e.g., larger than a predetermined threshold value), the control input generation unit 75 may set the time step number T in the expression (2) used for optimization to a value (e.g., the threshold value described above) smaller than the target time step number. In this case, the control input generation unit 75 sequentially determines the control input uₖ by solving the optimization problem based on the expression (2), for example, every time a predetermined number of time steps elapses.

In some embodiments, the control input generation unit 75 may solve the optimization problem based on the expression (2) for each predetermined event corresponding to the intermediate state for the accomplishment state of the objective task and determine the control input uₖ to be used. In this case, the control input generation unit 75 determines the time step number T in the expression (2) to be the number of time steps up to the next event occurrence. The event described above is, for example, an event in which the dynamics switches in the workspace 6. For example, when pick-and-place is the objective task, examples of the event include “the robot 5 grasps the target object” and “the robot 5 finishes carrying one of the target objects to the destination (goal) point.” For example, one or more events are predetermined for each type of the objective task, and information indicative of the events for each type of the objective task is stored in the storage device 4.

(8-7) Subtask Sequence Generation Unit

The subtask sequence generation unit 76 generates the subtask sequence Sr based on the control input information Icn supplied from the control input generation unit 75 and the subtask information I4 stored in the application information storage unit 41. In this case, by referring to the subtask information I4, the subtask sequence generation unit 76 recognizes subtasks that the robot 5 can accept and converts the control input for every time step indicated by the control input information Icn into subtasks.

For example, in the subtask information I4, there are defined functions representing two subtasks, the movement (reaching) of the robot hand and the grasping by the robot hand, as subtasks that can be accepted by the robot 5 when the objective task is pick-and-place. In this case, the function “Move” representing the reaching is, for example, a function that uses the following three arguments (parameters): the initial state of the robot 5 before the function is executed; the final state of the robot 5 after the function is executed; and the time to be required for executing the function. In addition, the function “Grasp” representing the grasping is, for example, a function that uses the following these arguments: the state of the robot 5 before the function is executed; the state of the target object to be grasped before the function is executed; and the logical variable δ. Here, the function “Grasp” indicates performing a grasping operation when the logical variable δ is “1”, and indicates performing a releasing operation when the logical variable δ is “0”. In this case, the subtask sequence generation unit 76 determines the function “Move” based on the trajectory of the robot hand determined by the control input for every time step indicated by the control input information Icn, and determines the function “Grasp” based on the transition of the logical variable δ in units of time step indicated by the control input information Icn.

Then, the subtask sequence generation unit 76 generates the subtask sequence Sr configured by the function “Move” and the function “Grasp”, and supplies the subtask sequence Sr to the robot 5. For example, if the objective task is “the target object (i=2) finally exists in the area G”, the subtask sequence generation unit 76 generates the operation sequence of the function “Move”, the function “Grasp”, the function “Move”, and the function “Grasp” for the robot hand closest to the target object 2. In this case, the robot hand closest to the target object (i=2) moves to the position of the target object 2 by the function “Move” for the first time, grasps the target object (i=2) by the function “Grasp” for the first time, moves to the area G by the function “Move” for the second time, and places the target object (i=2) in the area G by the function “Grasp” for the second time.

(9) Task Designation Screen Image

Next, an example of a screen image displayed when the instruction device 2 receives instructions relating to the objective task from an operator will be described.

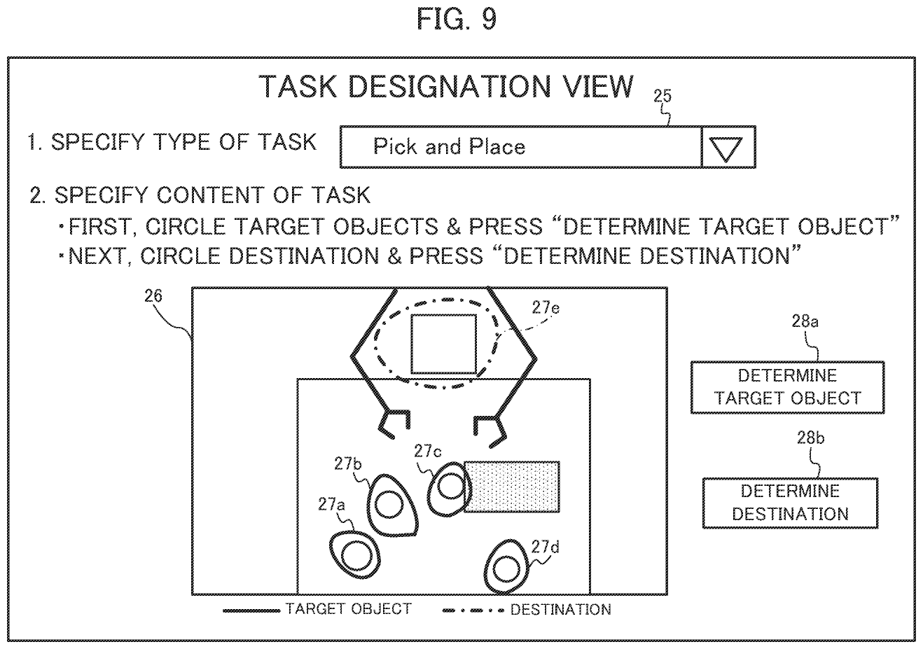

FIG. 9 shows a display example of a task designation screen image for specifying an objective task displayed by the instruction device 2. For example, the instruction device 2 receives, from the robot controller 1 of the task execution system 50 selected by the operator from the list of the task execution systems 50, a predetermined display signal, and thereby displays the task designation screen image shown in FIG. 9. The task designation screen image shown in FIG. 9 mainly includes a task type designation field 25, a workspace display field 26, and buttons 28 (28a and 28b).

The instruction device 2 receives an input specifying the type of the objective task in the task type designation field 25. Here, as an example, the task type designation field 25 is an input field in a pull-down menu format, and the instruction device 2 selectably lists possible candidates of the type of the objective task in the task type designation field 25. The instruction device 2 has accepted the designation of the pick-and-place as the type of the objective task. The objective task is not limited to the pick-and-place, and may be set to any kind of tasks such as a task involving screwdriver operations, a task of moving an object by a mobile robot, and the like.

Further, the instruction device 2 displays, in the workspace display field 26, a workspace image that is an image of the workspace captured by the measurement device 7, and receives the designation necessary for the execution of the objective task specified in the task type designation field 25. In the example shown in FIG. 9, the instruction device 2 receives inputs for respectively specifying target objects and the destination on the work space display field 26. Here, as an example, the instruction device 2 displays the marks 27a to 27d of the target objects by solid line, and displays the mark 27e of the destination by broken line. Then, the instruction device 2 recognizes the position information of the marks 27a to 27d drawn by the user as the information for specifying the position of the target objects, when it is detected that the target object determination button 28a is selected. Further, when detecting that the destination determination button 28b has been selected, the instruction device 2 recognizes the position information of the mark 27e drawn by the user after selecting the object determination button 28a as information for specifying the destination. Then, the instruction device 2 supplies the instruction signal D1 that includes information (in this case, the position information of the respective marks on the workspace image) specifying these target objects and destinations to the robot controller 1 belonging to the objective task execution system 50.

As described above, according to the task designation screen image illustrated in FIG. 9, the instruction device 2 suitably receives the user input relating to the designation of the type of the objective task and the designation of objects relating to the objective task, and suitably supplies the instruction signal D1 specifying the objective task to the robot controller 1.

Instead of receiving an input circling the target objects and the destination, the instruction device 2 may receive an input to specify a part of pixels constituting the target objects and the destination respectively by touch operation or click operation. In this instance, the instruction device 2 regards the position information of the specified pixels as the information which specifies the target objects and the destination, respectively, and supplies the position information to the robot controller 1 as the instruction signal D1. Instead of displaying the workspace image generated by the measurement device 7 in the workspace display field 26, the instruction device 2 may display a CAD image representing the environment in the workspace in the workspace display field 26. In this instance, the robot controller 1 transmits a display signal for displaying the CAD image representing the environment in the workspace to the instruction device 2 based on the recognition result Im generated by the abstract state setting unit 71 and the object model information I6 recording CAD data relating to the target object or the like.

(10) Processing Flow

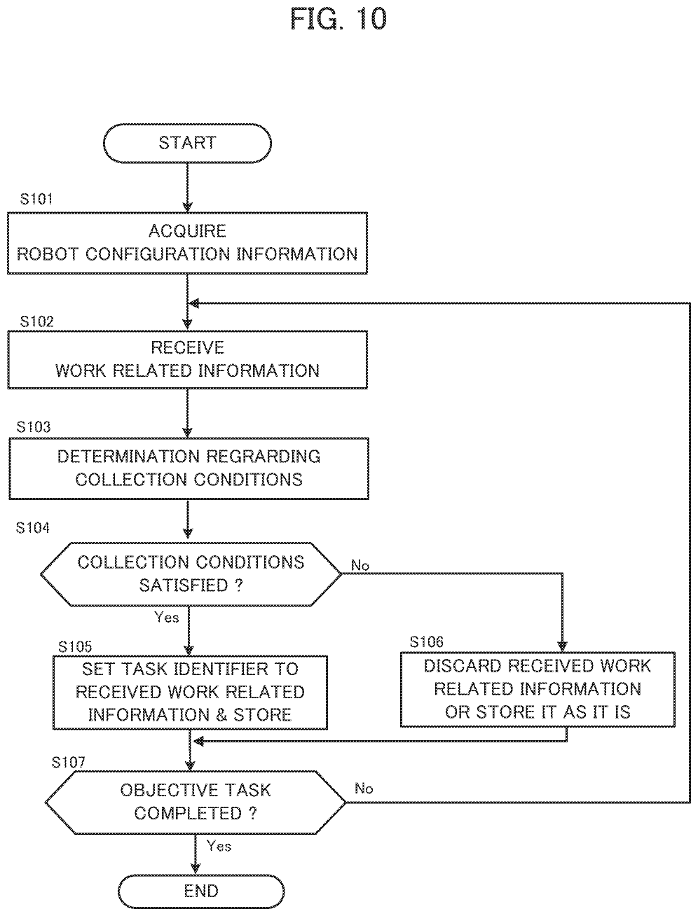

FIG. 10 illustrates an example of a flowchart showing an outline of a process related to reception and accumulation of the robot work related information D2 executed by the information collecting device 3 in the first example embodiment. The information collecting device 3 executes the process of the flowchart shown in FIG. 10 for each of the task execution systems 50 in which the objective task is specified by the instruction device 2.

First, the information acquisition unit 35 of the information collecting device 3 acquires the robot configuration information D21 (step S101). In this instance, the information acquisition unit 35 acquires the robot configuration information D21 by receiving the robot work related information D2 including at least the robot configuration information D21 from the objective task execution system 50 of interest. Thereafter, the information acquisition unit 35 receives the robot work related information D2 other than the robot configuration information D21 from the objective task execution system 50 of interest (step S102).

Next, the information acquisition unit 35 determines whether or not the collection condition(s) are satisfied (step S103). In this instance, the information acquisition unit 35 determines whether or not the set collection conditions are satisfied for the robot work related information D2 transmitted from the objective task execution system 50 of interest. Examples of the collection conditions include a condition relating to the configuration of the robot 5 indicated by the robot configuration information D21 acquired at step S101 and a condition (e.g., a condition relating to the date and time) other than the configuration of the robot 5.

When it is determined in the determination regarding the collection conditions at step S103 that the collection conditions are satisfied (step S104; Yes), the task identifier setting unit 36 sets the task identifier to the robot work related information D2 received at step S103 and stores the robot work related information D2 including the set task identifier in the robot work related information storage unit 42 (step S105). In this instance, the task identifier setting unit 36 divides the robot work related information D2 based on the date and time information into segmentations per subtask execution period, and sets the task identifier indicating at least the corresponding subtask for each of the segmentations of the robot work related information D2.

On the other hand, in the determination of the collection conditions at step S102, when it is determined that the collection conditions are not satisfied (step S104; No), the information acquisition unit 35 discards the received robot work related information D2 or stores the received robot work related information D2 in the robot work related information storage unit 42 as it is without setting the task identifier (step S106).

Next, the information collecting device 3 determines whether or not the objective task is completed in the objective task execution system 50 of interest (step S107). In this case, for example, the information collecting device 3 determines that the objective task has been completed in the objective task execution system 50 of interest when it has not been received the robot work related information D2 for a predetermined time or longer, or when it has received the information indicating that the objective task has been completed from the task execution system 50 of interest or the instruction device 2. When it is determined that the objective task has been completed (step S107; Yes), the information collecting device 3 terminates the process of the flowchart. On the other hand, when it is determined that the objective task has not been completed (step S107; No), the information collecting device 3 gets back to the process at step S102 and continues to perform the process relating to the reception and accumulation of the robot work related information D2.

(11) Modifications

Next, a description will be given of modifications of the first example embodiment. The following modifications may be applied to the first example embodiment described above in any combination.

(First Modification)

A part of the functions of the information collecting device 3 may be provided in each task execution system 50. For example, the robot controller 1 of each task execution system 50 may perform processing corresponding to a part of the functions of the information acquisition unit 35.

In this instance, the robot controller 1 of each task execution system 50 collects various types of information generated in the each objective task execution system 50 from the robot 5, the measurement device 7, or the like to generate the robot work related information D2. Further, the robot controller 1 determines whether or not the collection conditions, which are supplied from the instructing device 2 or the information collecting device 3 or the like or previously stored in the memory 12, are satisfied. Then, only when it is determined that the collection conditions are satisfied, the robot controller 1 transmits the robot work related information D2 to the information collecting device 3. In this aspect as well, the information collecting device 3 may suitably store information that is the robot work related information D2 tagged with the task identifier and use it for updating application information or the like.

Further, one of the robot controllers 1 may function as the information collecting device 3 to execute both the processes to be executed by the robot controller 1 and by the information collecting device 3 shown in FIG. 1. As such, the robot management system 100 may be implemented in a master-slave configuration. In yet another example, the robot controller 1 of each task execution system 50 may each function as the information collecting device 3. In this case, a robot controller 1 collects the work related information generated in the task execution system 50 to which the robot controller belongs, sets the task identifier, and stores the work related information to which the task identifier is set.

(Second Modification)

The block configuration of the robot controller 1 shown in FIG. 7 is an example, and various changes may be applied thereto.

For example, information on the candidates φ for the sequence of operations to be instructed to the robot 5 is stored in advance in the storage device 4, and based on the information, the robot controller 1 executes the optimization process to be executed by the control input generation unit 75. Thus, the robot controller 1 performs selection of the optimum candidate φ and determination of the control input of the robot 5. In this instance, the robot controller 1 may not have a function corresponding to the abstract state setting unit 71, the target logical formula generation unit 72, and the time step logical formula generation unit 73 in generating the subtask sequence Sr. Thus, information on the execution results from a part of the functional blocks in the robot controller 1 shown in FIG. 7 may be stored in advance in the application information storage unit 41.

In another example, the application information includes design information such as a flowchart for designing the subtask sequence Sr to complete the objective task in advance, and the robot controller 1 may generate the subtask sequence Sr by referring to the design information. For example, JP2017-39170A discloses a specific example of executing a task based on a pre-designed task sequence.

### Second Example Embodiment

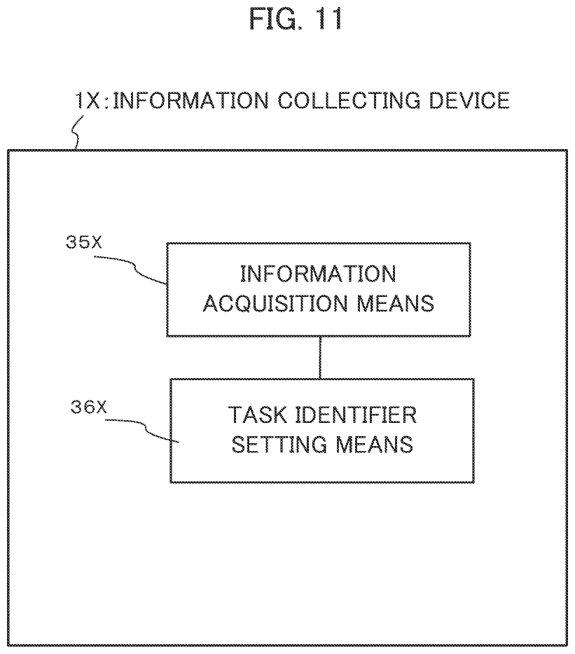

FIG. 11 shows a schematic configuration diagram of an information collecting device 3X according to the second example embodiment. The information collecting device 3X mainly includes an information acquisition means 35X and a task identifier setting means 36X. The information collecting device 3X may be configured by a plurality of devices.

The information acquisition means 35X is configured to acquire work related information relating to a work of a robot. Examples of the information acquisition means 35X include the information acquisition unit 35 in the first example embodiment.

The task identifier setting means 36X is configured to set an identifier of a task executed by the robot to the work related information. The work related information to which the task identifier is set is stored in a memory of the information collecting device 3X or an external memory. Examples of the task identifier setting means 36X include the task identifier setting unit 36 in the first example embodiment.

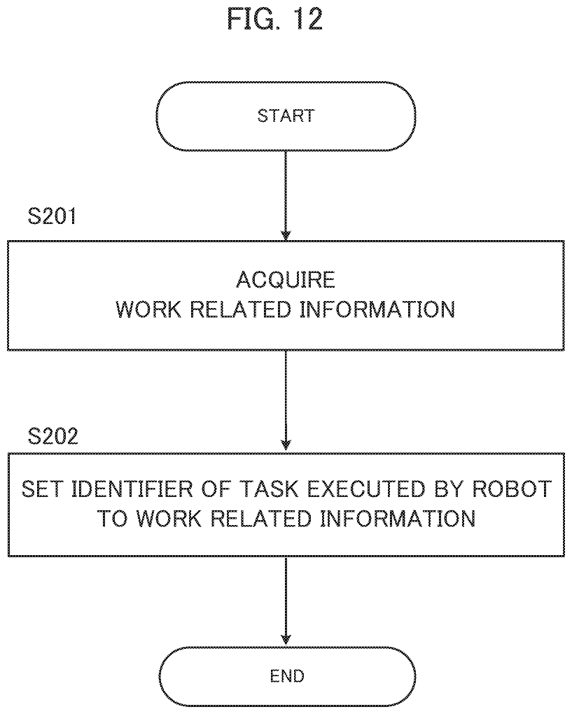

FIG. 12 shows an example of the flowchart executed by the information collecting device 3X in the second example embodiment. The information acquisition means 35X acquires work related information relating to a work of a robot (step S201). The task identifier setting means 36X sets an identifier of a task executed by the robot to the work related information (step S202).

According to the second example embodiment, the information collecting device 3X sets an identifier of a task executed by a robot to work related information relating to the task of the robot. Thus, it is possible to facilitate analysis of the work related information and the learning for each task.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1 Robot controller
2 Instruction device
3, 3X Data collection device
Robot
7 Measurement device
41 Application information storage unit
42 Robot work related information storage unit
43 Updated application information storage unit
50 Task execution system
100 Robot Management System

What is claimed is:

1. An information collecting device comprising:
at least one memory configured to store instructions; and
at least one processor configured to execute the instructions to:
acquire work related information relating to a work of a robot; and
set an identifier of a task executed by the robot to the work related information.

2. The information collecting device according to claim 1,
wherein the identifier is information for at least identifying a subtask which is a task in a unit that the robot can accept, and
wherein the at least one processor is configured to execute the instructions to set, to each of the work related information segmented based on an execution period of each subtask, the identifier indicative of the each subtask.

3. The information collecting device according to claim 2,
wherein the robot executes a sequence of the subtasks, the sequence being generated based on a logical formula representing, according to a temporal logic, an objective task to be executed by the robot.

4. The information collecting device according to claim 2,
wherein the identifier is information for identifying the subtask and an objective task to be executed by the robot, and
wherein the at least one processor is configured to execute the instructions to set, to each of the work related information segmented based on the execution period of each subtask, the identifier indicative of the each subtask and the objective task.

5. The information collecting device according to claim 1,
wherein the at least one processor is configured to execute the instructions to determine whether or not a collection condition, which is a condition for making a determination of collecting the work related information, is satisfied, and
wherein the at least one processor is configured to execute the instructions to set the identifier to the work related information if the collection condition is satisfied.

6. The information collecting device according to claim 5,
wherein the at least one processor is configured to execute the instructions to discard the work related information or store the work related information without setting the identifier thereto, if the collection condition is not satisfied.

7. The information collecting device according to claim 1,
wherein the robot is one or more robots provided in each of plural environments, and
wherein, in each of plural environments, there is provided a task execution system which includes the one or more robots, and
wherein the at least one processor is configured to execute the instructions to receive the work related information from each of the task execution systems, and
wherein the at least one processor is configured to execute the instructions to set the identifier indicative of the task executed by the one or more robots to the work related information received from each of the task execution systems.

8. The information collecting device according to claim 1,
wherein the at least one processor is configured to execute the instructions to acquire robot configuration information regarding a configuration of the robot.

9. An information collecting method executed by a computer, the information collecting method comprising:
acquiring work related information relating to a work of a robot; and
setting an identifier of a task executed by the robot to the work related information.

10. A non-transitory computer readable storage medium storing a program executed by a computer, the program causing the computer to:
acquire work related information relating to a work of a robot; and
set an identifier of a task executed by the robot to the work related information.
